(19) United States
(12) Patent Application Publication
(10) Pub. No.: US 2018/0107358 A1
(43) Pub. Date: Apr. 19, 2018

(54) MULTIPLE-DISPLAY UNIFICATION SYSTEM AND METHOD

(71) Applicant: International Business Machines Corporation, Armonk, NY (US)

(72) Inventors: Sebastian M. Chodakowski, Winchester (GB); David A. Chynoweth, Winchester (GB); Joshua E. Vines, Winchester (GB)

(73) Assignee: International Business Machines Corporation, Armonk, NY (US)

(21) Appl. No.: 15/295,080

(22) Filed: Oct. 17, 2016

(51) Int. Cl. G06F 3/0486; G06F 3/0484; G06F 3/14

(52) U.S. Cl. CPC G06F 3/0486; G06F 3/04883; G06F 3/1423; G06F 3/04845

(57) ABSTRACT

A method for providing a cohesive user experience when using multiple displays includes displaying a first graphical element on a first display screen, and a second graphical element on a second display screen. The method enables a user to move at least one of the first and second graphical elements until the first and second graphical elements are substantially aligned with one another across the first and second display screens. The method further enables the user to resize at least one of the first and second graphical elements until the first and second graphical elements are scaled similarly on the first and second display screens. The method automatically adjusts a relative understood position of the first and second display screens and scales graphical objects displayed across the first and second display screens. A corresponding system and computer program product are also disclosed.

### BACKGROUND

### Field of the Invention

This invention relates to systems and methods for providing a more cohesive experience when using multiple display screens.

### Background of the Invention

As high quality display screens become more affordable and mobile devices increasingly more common, multiple display screens are frequently used together to achieve a larger display area or to extend the functionality of mobile devices such as laptops, tablets, and cell phones. Companies often join together a number of smaller displays to create large digital billboards, banners, and signage. In such applications, it is important that each display screen be precisely aligned to avoid distorted images and jarring movement when visual objects move between the displays.

Companies and individuals may in certain cases decide to forego traditional desktop personal computers and workstations and instead utilize laptops with additional monitors to increase mobility without sacrificing productivity. In such situations, it is important to have correctly aligned display screens to avoid frustrating inconsistencies when visual objects are moved between the display screens. This becomes particularly important with laptops since they are frequently moved and are rarely put back in the same location relative to an external monitor. Any iterative solution to this problem is infeasible as it would regularly waste a significant amount of time.

It may also be important to have consistent sizing of visual elements across monitors, especially in design and content creation applications where additional display screens are used to increase the size of the digital canvas that is available. In such cases, a misalignment of even a few pixels can lead to additional work and high screen resolution becomes essential to provide a correct level of detail.

In view of the foregoing, what are needed are systems and methods to provide a more cohesive experience when using multiple displays. Ideally, such systems and methods will enable a user to quickly align display screens and correctly size visual elements across multiple display screens.

### SUMMARY

The invention has been developed in response to the present state of the art and, in particular, in response to the problems and needs in the art that have not yet been fully solved by currently available systems and methods. Accordingly, systems and methods have been developed to provide a more cohesive user experience when using multiple displays. The features and advantages of the invention will become more fully apparent from the following description and appended claims, or may be learned by practice of the invention as set forth hereinafter.

Consistent with the foregoing, a method for providing a cohesive user experience when using multiple displays is disclosed. In one embodiment, such a method includes displaying a first graphical element on a first display screen, and a second graphical element on a second display screen. The method enables a user to move at least one of the first and second graphical elements until the first and second graphical elements are substantially aligned with one another across the first and second display screens. The method further enables the user to resize at least one of the first and second graphical elements until the first and second graphical elements are scaled similarly on the first and second display screens. In accordance with the movement and resize of the graphical elements, the method automatically adjusts a relative understood position of the first and second display screens and scales graphical objects displayed across the first and second display screens.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system which may implement a system and method in accordance with the invention on various display screens;

FIG. 2 shows presentation of a first graphical element on a first display screen, and presentation of a second graphical element on a second display screen;

FIG. 3 shows movement of the second graphical element on the second display screen to align it with the first graphical element on the first display screen;

FIG. 4 shows resize of the second graphical element on the second display screen to scale it similarly to the first graphical element on the first display screen;

FIG. 5 shows movement of a graphical object, in this example a cursor, across the first and second display screens;

FIG. 6 shows alignment and scaling of a graphical object, in this example a window and associated content, across the first and second display screens;

FIGS. 7 through 9 show how embodiments of the invention may be modified to work with more than two display screens;

FIG. 10 shows how a camera may, in certain embodiments, be used to provide proper alignment and scaling of display screens; and

FIG. 11 shows various modules that may be used to implement various features and functions of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

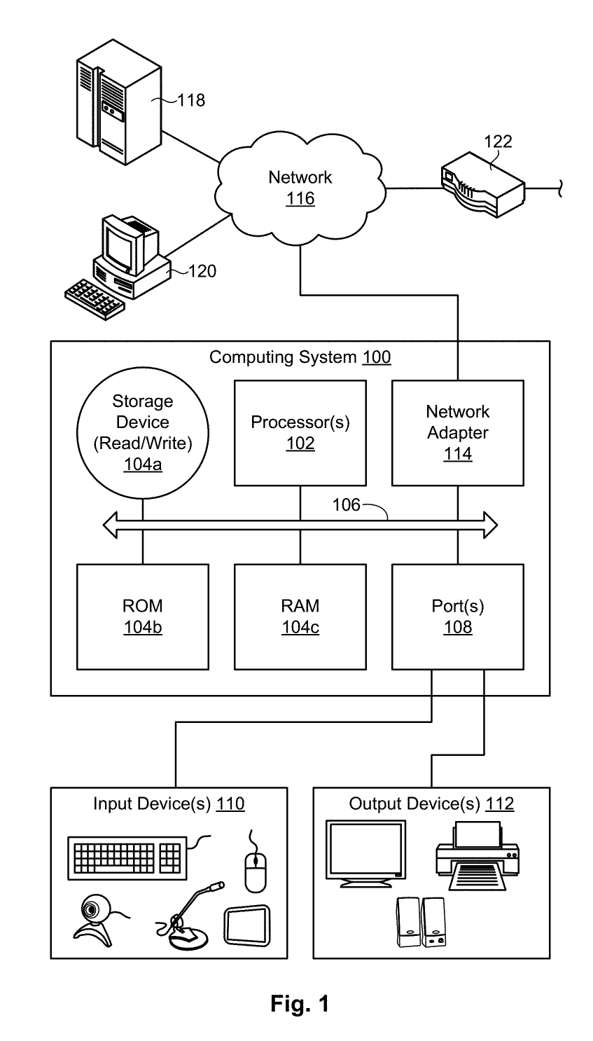

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

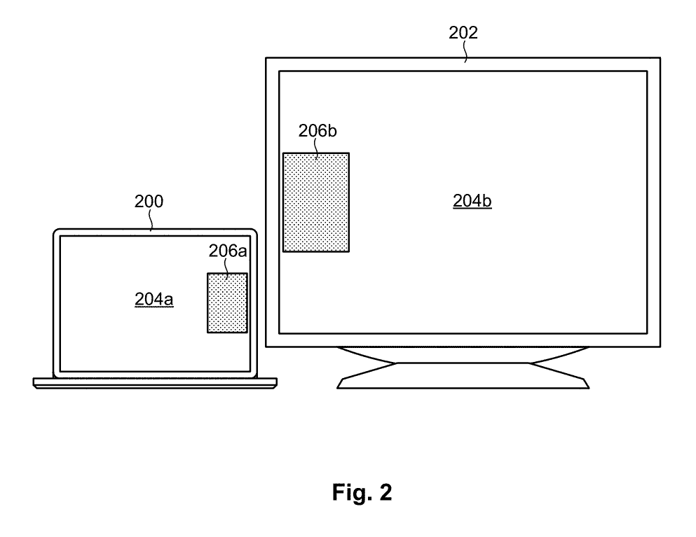

Referring to FIG. 2, as previously mentioned, multiple display screens are frequently used together to achieve a larger display area or to extend the functionality of mobile devices such as laptops, tablets, or cell phones. In some cases, multiple displays may be joined together to create large digital billboards, banners, and signage. Companies and individuals may in certain cases forego traditional desktop personal computers and workstations and instead utilize laptops with additional monitors to increase mobility. In other cases, multiple monitors may be used with desktop personal computers or workstations to increase an amount of screen area to display documents and applications. In such situations, it is important to have correctly aligned display screens to avoid frustrating inconsistencies when visual objects are displayed or moved across the display screens. This becomes particularly important with laptops since they are frequently moved and are rarely put back in the exact same location relative to an external monitor.

FIG. 2 shows a typical scenario of a laptop computer 200 coupled to an external monitor 202. As shown, a display screen 204a of the laptop computer 200 is substantially smaller than a display screen 204b of the external monitor 202. Furthermore, the display screen 204a of the laptop computer 200 sits substantially below the display screen 204b of the external monitor 202. In addition to the size difference between the display screens 204a, 204b, the display screens 204a, 204b may have differing resolutions and pixel densities (e.g. pixels per inch). The result is that the same graphical objects (windows, cursors, widgets, etc.) may appear to be different sizes when displayed on the display screens 204a, 204b. The graphical objects may also appear disjointed when spanning the display screens 204a, 204b or when moved across the display screens 204a, 204b. In many cases, a graphical object may not follow a straight line as it moves across the display screens 204a, 204b, instead following a disjointed path. A graphical object may also change size as it moves across the display screens 204a, 204b, potentially displaying different portions of the graphical object at a different scale. This, in turn, may decrease efficiency, cause annoyances to a user, and possibly cause mistakes in a work product.

In order to address the problems described above and provide a more cohesive user experiences when using multiple display screens 204a, 204b, systems and methods in accordance with the invention may compensate for physical misalignments and/or differing resolutions or pixel densities of multiple display screens 204a, 204b. As shown in FIG. 2, systems and methods in accordance with the invention may display a graphical element 206, in this example a rectangle 206, on each display screen 204. These graphical elements 206a, 206b may be manipulated (e.g., moved, resized, etc.) by a user with a mouse, cursor, stylus, or the like, to compensate for the physical misalignments and/or differing resolutions or pixel densities of the display screens 204a, 204b.

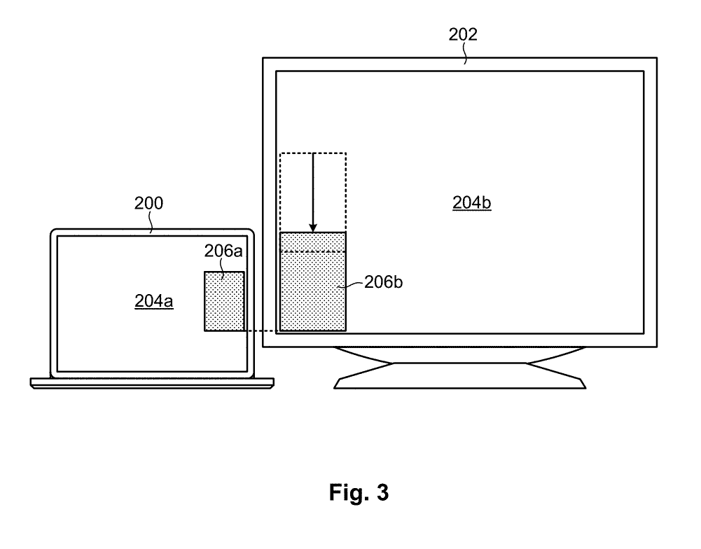

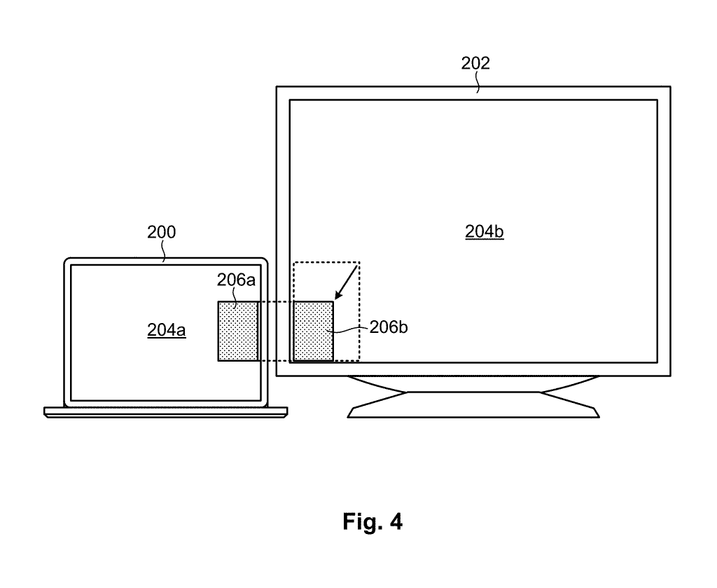

For example, as shown in FIG. 3, a user may initially move the graphical element 206b on the display screen 204b to visually align it with the graphical element 206a on the other display screen 204a. In the illustrated example, the graphical element 206b is moved down with a cursor, finger, or the like, so that its lower edge is substantially aligned with the lower edge of the graphical element 206a. The graphical element 206a may also be moved if needed to visually align its lower edge with the lower edge of the graphical element 206b. Thus, alignment of the graphical elements 206a, 206b may require movement of one or more of the graphical elements 206a, 206b with a cursor, finger, stylus, or the like. Alignment is not limited to the lower edge of the graphical elements 206. In other embodiments, the upper edges of the graphical elements 206a, 206b may be initially aligned or the graphical elements 206a, 206b may be brought into approximate alignment and the edges may be more exactly aligned during the resize step illustrated in FIG. 4.

Referring to FIG. 4, once some portion of the graphical elements 206a, 206b are substantially aligned, one or more of the graphical elements 206a, 206b may be resized so that they appear to the user to be the same size or substantially the same size on each of the display screens 204a, 204b. In certain embodiments, the graphical elements 206a, 206b may be resized by dragging a corner of the graphical elements 206a, 206b, similar to resizing windows in many operating systems. The graphical elements 206a, 206b may, in certain embodiments, maintain their same shape or proportions when they are resized although this is not necessary in all embodiments. In other embodiments, an upper or lower edge of the graphical elements 206a, 206b may be dragged up or down to resize the graphical elements 206a, 206b until they have the same vertical dimensions or substantially the same vertical dimensions.

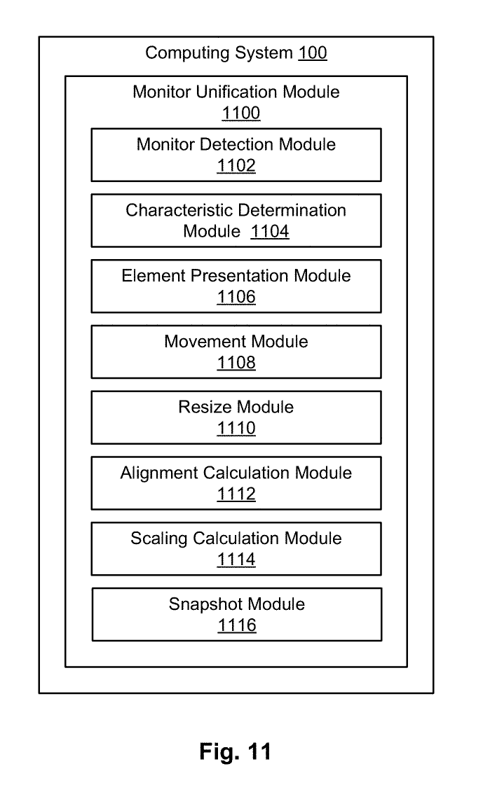

Once the graphical elements 206a, 206b are aligned and resized so that their top and bottom edges are substantially visually aligned with one another, a monitor unification module 1100 in accordance with the invention, as will be explained in more detail in association with FIG. 11, may adjust a relative understood position of the display screens 204a, 204b and scale objects on the display screens 204a, 204b so that they appear to be substantially the same size when they move across the display screens 204a, 204b. Specifically, the monitor unification module 1100 may compensate for the different physical alignments and differing resolutions and pixel densities of the display screens 204a, 204b. This will provide a much more cohesive user experience and cause the separate display screens 204a, 204b to act more like one large display screen 204.

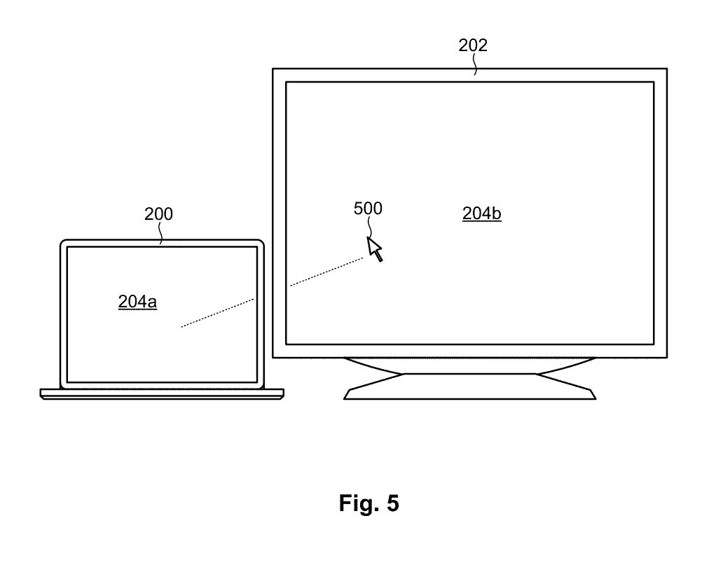

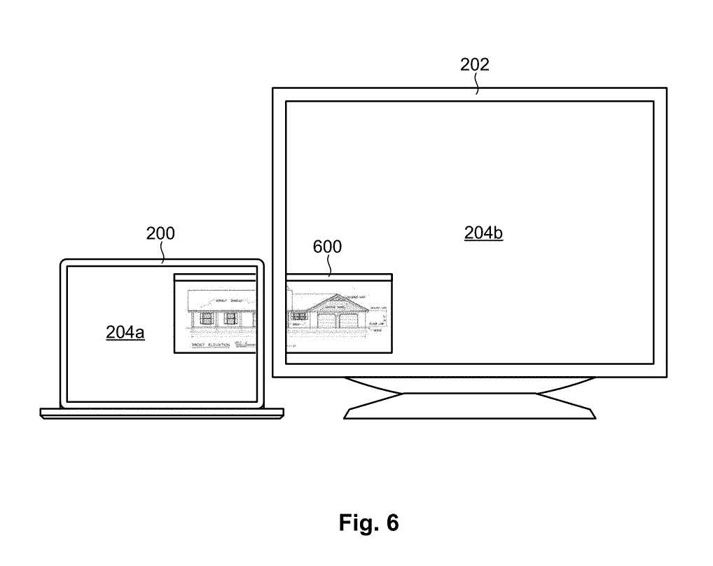

For example, as shown in FIG. 5, after the monitor unification module 1100 performs the above-described compensation, a cursor 500 or other graphical object 500 that moves across the display screens 204a, 204b may follow a straight line, regardless of the vertical position of the cursor 500 or graphical object 500 as it travels across the display screens 204a, 204b. Furthermore, graphical objects 600 such as windows 600 may be scaled similarly on both display screens 204a, 204b when they travel across or span the display screens 204a, 204b, as shown in FIG. 6.

In certain embodiments, the monitor unification module 1100 may take into account bezels around the display screens 204a, 204b as well as any distance between the bezels of the two display screen 204a, 204b. The thickness of the bezels, as well as the distance between the bezels of the monitors 200, 202, may affect the appearance of graphical objects as they move across the display screens 204a, 204b. For example, a cursor moving at an angle from one display screen 204a to the other 204b may not appear to travel along a straight line unless the bezels and any distance between the bezels is taken into account.

Bezels and any distance between the bezels may, in certain embodiments, be ignored (treated like they don't exist) for graphical objects that span the display screens 204a, 204b. This would enable all of a graphical object to be seen when spanning the display screens 204a, 204b. In other embodiments, the bezels and distance between the bezels may obscure part of a graphical object as it spans or passes across the display screens 204a, 204b. This may provide a more realistic appearance and allow the graphical objects to maintain their geometric proportions, while hiding from view part of the graphical objects. The amount of the graphical objects hidden from view may be reduced by using monitors 200, 202 with thinner bezels and/or less distance the bezels (such as by having the bezels abut another). In certain embodiments, the monitor unification module 1100 may gather information about bezel width and any distance between the bezels from a user, from the monitor itself (such as from Extended Display Identification Data (EDID) data), or other sources so that these factors may be taken into account when displaying or translating graphical objects across the display screens 204a, 204b.

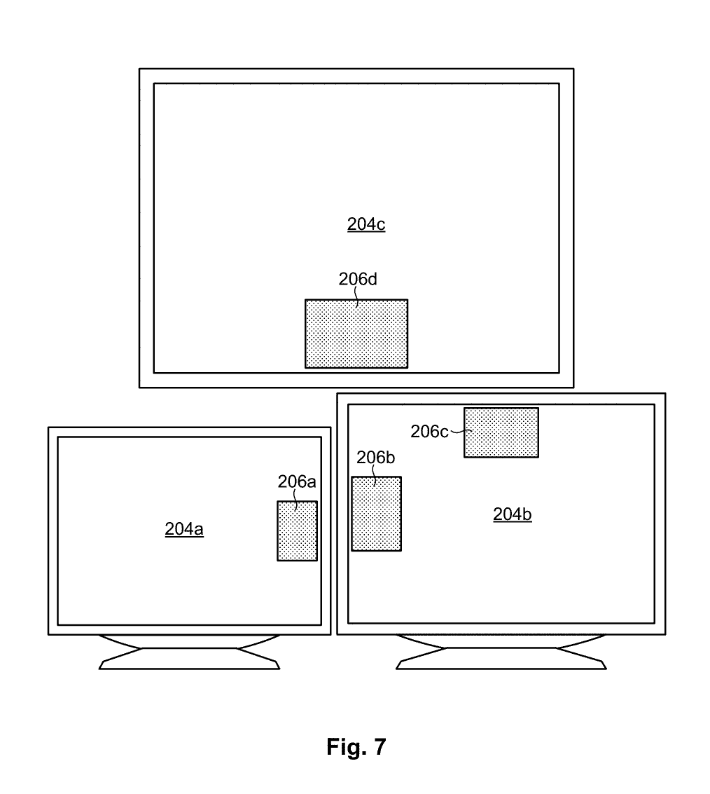

Referring to FIGS. 7 through 9, the systems and methods described herein may in certain embodiments be adapted to work with more than two display screens 204. For example, FIG. 7 shows a scenario using three display screens 204a-c. Graphical elements 204a-d may be displayed on the display screens 204a-c for the purposes of “unifying” the display screens. As shown, the display screen 204b may include two graphical elements 206b, 206c to enable it to be unified with the display screen 204a to the left and the display screen 204c above.

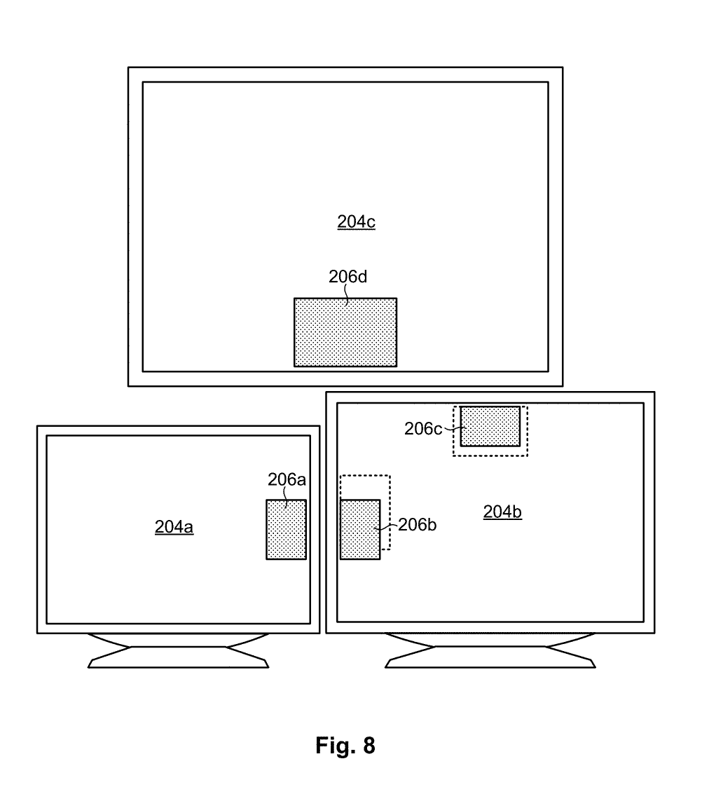

To unify the display screens 204a, 204b to compensate for differences in physical alignment, resolution, and/or pixel density, the graphical elements 206a, 206b may be aligned and resized in the manner previously described, as shown in FIG. 8. As can be observed in FIG. 8, when the graphical element 206b is resized to match the size of the graphical element 206a, the other graphical element 206c on the display screen 204b may automatically change in size to reflect the resize. That is, the graphical elements 206b, 206c may maintain the same proportions relative to one another.

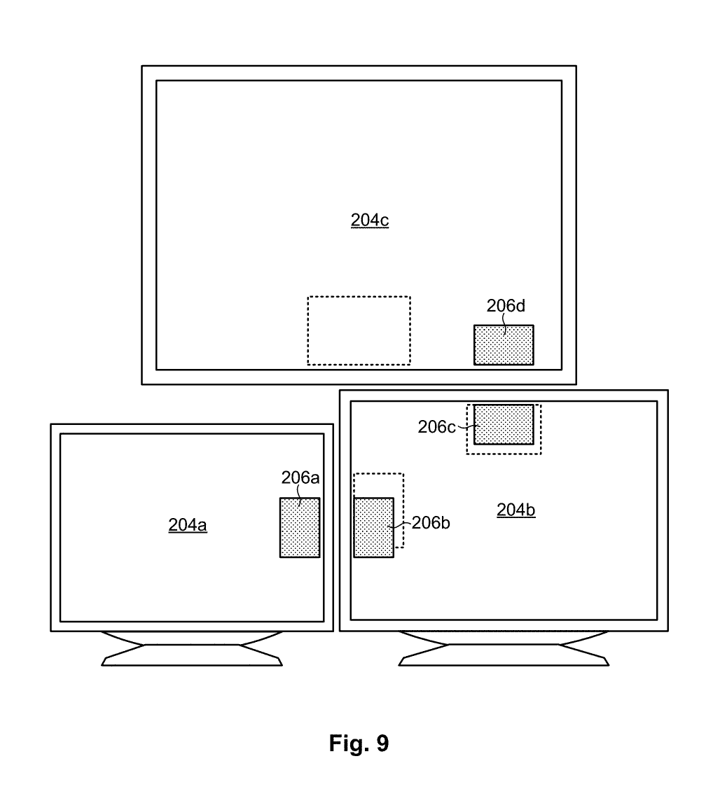

After the graphical elements 206a, 206b have been aligned and resized to match one another, thereby causing the display screens 204a, 204b to be “unified” with one another, the display screens 204b, 204c may then be unified. This may be accomplished by aligning and resizing the graphical elements 206c, 206d. Because the display screens 204b, 204c are in a stacked configuration, the graphical elements 206c, 206d may be moved horizontally as opposed to vertically. Because resizing the graphical element 206c will cause a corresponding resize of the graphical element 206b (and thereby possibly cause a mismatch with graphical element 206a), only the graphical element 206d may be resized to match the graphical element 206c. Thus, the graphical element 206d may be aligned with the graphical element 206c and resized to substantially match the size of the graphical element 206c, as shown in FIG. 9. This will unify the display screens 204b, 204c without changing the relationship between the display screens 204a, 204b. This final step will result in all of the display screens 204a-c acting as a single large display.

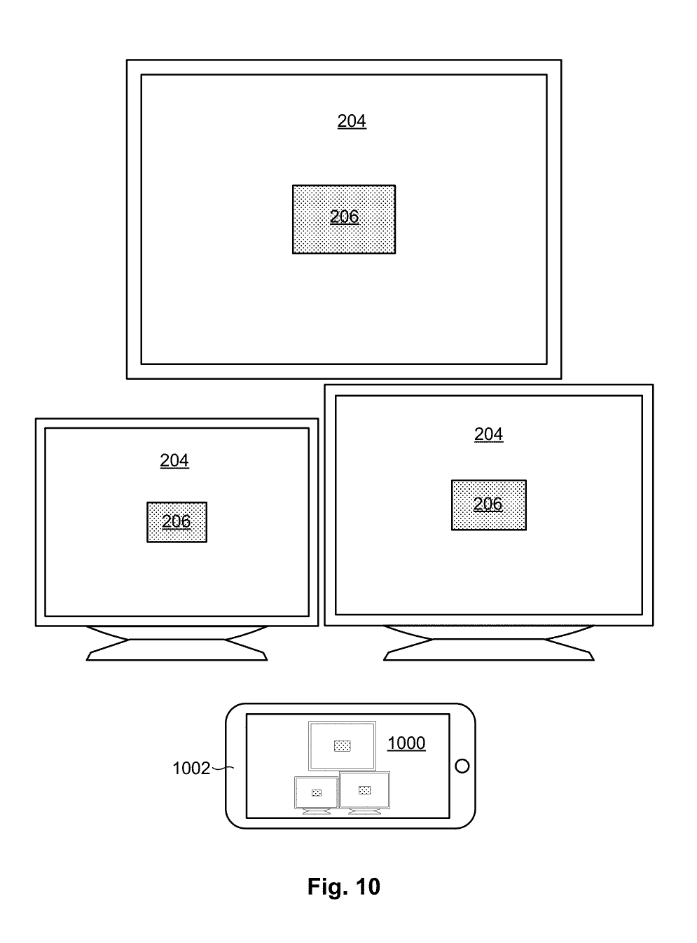

Referring to FIG. 10, in certain embodiments, a camera 1000 (shown in this embodiments as a camera 1000 on a mobile computing device 1002) may be used to assist in unifying multiple display screens 204, possibly without requiring a user to move around and/or resize graphical elements 206 on the display screens 204. The monitor unification module 1100 previously discussed may cause one or more graphical elements 206 to be displayed on each display screen 204 in the group. A user may then take a photograph of the display screens 204 and associated graphical elements 206. The photograph may be communicated to the monitor unification module 1100 which may analyze the photograph, including the sizes of the display screens 204 and graphical elements 206 thereon. The monitor unification module 1100 may also analyze the relative positions and alignments of the display screens 204. Based on this information as well as information such as screen resolutions and pixel densities (which may be acquired, for example, from a user or EDID data), the monitor unification module 1100 may adjust a relative understood position of the display screens 204 and scale graphical objects on the display screens 204 so that they appear to be same size when travelling across or spanning the display screens 204. Stated otherwise, the monitor unification module 1100 may “unify” the display screens 204 such that they perform like one large display screen 204.

Referring to FIG. 11, the monitor unification module 1100 previously discussed may include one or more sub-modules to provide various features and functions. These sub-modules may be implemented in hardware, software, firmware, or combinations thereof. As shown, these sub-modules may include one or more of a monitor detection module 1102, characteristic determination module 1104, element presentation module 1106, movement module 1108, resize module 1110, alignment calculation module 1112, scaling calculation module 1114, and snapshot module 1116. The sub-modules are presented by way of example and not limitation. The monitor unification module 1100 may include more or fewer sub-modules than those illustrated, or the functionality of the sub-modules may be combined or split into additional sub-modules.

The monitor detection module 1102 may be configured to detect monitors that are connected to a computing system 100. This detection may occur upon request or automatically when a monitor is connected to the computing system 100. The characteristic determination module 1104 may determine characteristics, such as resolution, pixel density, screen size, bezel width, and the like, associated each of the monitors that are connected to the computing system 100. In certain embodiments, these characteristics are pulled from the monitor itself, such as from a memory within the monitor. For example, EDID data which may indicate vertical and horizontal lengths of a monitor as well as its resolution, may be pulled from the monitor. In other embodiments, the characteristic determination module 1104 determines models of the monitors and looks up information about the particular models in a database stored on the computing system 100 or pulled from an external source such as the Internet. In yet other embodiments, the characteristic determination module 1104 enables a user to manually input characteristics about the monitors. These characteristics may be helpful to “unify” the display screens 204 and ensure that graphical objects appear correctly when translated or displayed across the display screens 204.

The element presentation module 1106 may present graphical elements 206 on the display screens 204 for the purpose of unifying the display screens 204. These graphical elements 206 may take on various forms and not limited to any particular shape or orientation. In certain embodiments, the graphical elements 206 are rectangles as illustrated in FIGS. 2 through 9. These graphical elements 206 may be manipulated (moved, resized, etc.) in order to unify the display screens 204. The movement module 1108 may enable a user to move the graphical elements 206 on the display screens 204. For side-by-side monitors, the movement module 1108 may enable vertical translation of the graphical elements 206. For stacked monitors, the movement module 1108 may enable horizontal translation of the graphical elements 206. The resize module 1110, by contrast, may enable resizing of the graphical elements 206. In certain embodiments, this may be accomplished by selecting and dragging a corner or edge of the graphical elements 206 until they achieve a desired size.

Based on the way the graphical elements 206 are moved and resized, the alignment calculation module 1112 may adjust a relative understood position of the display screens 204 (i.e., adjust an understanding of the computing system 100 as to where the display screens 204 are located relative to one another). This will enable compensation for any misalignment. This, in turn, will enable a graphical object (e.g., cursor, window, image, etc.) to transition from one display screen 204 to another along a straight line without jumping or lurching during the transition. The scaling calculation module 1114, by contrast, may scale graphical objects on the display screens 204 so that they appear to be the same size or substantially the same size when spanning or transitioning across the display screens 204. The scaling calculation module 1114 may take into account the dimensions, resolutions, and/or pixel densities of the display screens 204 when making this calculation.

The snapshot module 1116 may enable a snapshot to be taken of multiple monitors and associated graphical elements 206 as was discussed in association with FIG. 10. This snapshot may be analyzed by the alignment calculation module 1112 and scaling calculation module 1114 to determine the physical alignment between the monitors and the scaling that needs to occur to make graphical objects appear to be the same size or substantially the same size as they pass therebetween. In certain embodiments, this may be accomplished without having to move and/or resize the graphical elements 206 on the display screens 204. That is, the alignment calculation module 1112 and scaling calculation module 1114 may analyze the snapshot and determine, from the size and relative position of the monitors, the size and position of the graphical elements 206 on the display screens 204, and the resolutions and/or pixel densities of the monitors, the adjustments that need to be made to make the monitors correctly function together.

Different variations of the disclosed systems and methods are possible. For example, it is contemplated that the monitor unification module 1100 could enable different monitors in a group to maintain their current resolutions and size graphical objects contained entirely on their display screens 204 in accordance with their native resolutions. Thus, a graphical object on a first monitor may appear to be a first size while the same graphical object on a second monitor may appear to be a second size different from the first size. By contrast, when the graphical object is translated across the first monitor and second monitor, the monitor unification module 1100 may gradually shrink or enlarge the graphical object from the first size to the second size. Any graphical object that spans the first and second monitor may have a size between the first and second size, depending on much of the graphical object is displayed on the first monitor and second monitor. While spanning the first and second monitors, the graphical object may be scaled similarly on each of the first and second monitors so that it appears in a normal non-disjoint manner. Alternatively, a graphical object that is moved from a first monitor to a second monitor may snap down or up in size to the resolution of the monitor to which it is being moved once the graphical object is entirely contained within the destination display screen 204. Before it is entirely contained within the destination display screen, the graphical object may be scaled in accordance with the source or originating display screen 204.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for providing a cohesive user experience when using multiple displays, the method comprising:
displaying a first graphical element on a first display screen;
displaying a second graphical element on a second display screen;
enabling a user to move at least one of the first and second graphical elements until the first and second graphical elements are substantially aligned with one another across the first and second display screens;
enabling a user to resize at least one of the first and second graphical elements until the first and second graphical elements are scaled similarly on the first and second display screens;
automatically adjusting a relative understood position of the first and second display screens in accordance with the move; and
automatically scaling graphical objects spanning the first and second display screens in accordance with the resize.

2. The method of claim 1, wherein enabling a user to move at least one of the first and second graphical elements comprises enabling a user to drag at least one of the first and second graphical elements.

3. The method of claim 2, wherein enabling a user to drag at least one of the first and second graphical elements comprises enabling a user to drag at least one of the first and second graphical elements using one of a cursor, finger, and stylus.

4. The method of claim 1, wherein enabling a user to resize at least one of the first and second graphical elements comprises enabling a user to visually resize at least one of the first and second graphical elements using one of a cursor, finger, and stylus.

5. The method of claim 1, wherein substantially aligned is one of substantially vertically aligned and substantially horizontally aligned.

6. The method of claim 1, wherein the first and second graphical elements are rectangles.

7. The method of claim 1, wherein automatically scaling graphical objects spanning the first and second display screens comprises automatically scaling graphical objects on the first and second display screens so that they appear to be substantially the same size on either display screen.

8. A computer program product to provide a cohesive user experience when using multiple displays, the computer program product comprising a computer-readable storage medium having computer-usable program code embodied therein, the computer-usable program code configured to perform the following when executed by at least one processor:
display a first graphical element on a first display screen;
display a second graphical element on a second display screen;
enable a user to move at least one of the first and second graphical elements until the first and second graphical elements are substantially aligned with one another across the first and second display screens;
enable a user to resize at least one of the first and second graphical elements until the first and second graphical elements are scaled similarly on the first and second display screens;
automatically adjust a relative understood position of the first and second display screens in accordance with the move; and
automatically scale graphical objects spanning the first and second display screens in accordance with the resize.

9. The computer program product of claim 8, wherein enabling a user to move at least one of the first and second graphical elements comprises enabling a user to drag at least one of the first and second graphical elements.

10. The computer program product of claim 9, wherein enabling a user to drag at least one of the first and second graphical elements comprises enabling a user to drag at least one of the first and second graphical elements using one of a cursor, finger, and stylus.

11. The computer program product of claim 8, wherein enabling a user to resize at least one of the first and second graphical elements comprises enabling a user to visually resize at least one of the first and second graphical elements using one of a cursor, finger, and stylus.

12. The computer program product of claim 8, wherein substantially aligned is one of substantially vertically aligned and substantially horizontally aligned.

13. The computer program product of claim 8, wherein the first and second graphical elements are rectangles.

14. The computer program product of claim 8, wherein automatically scaling graphical objects spanning the first and second display screens comprises automatically scaling graphical objects on the first and second display screens so that they appear to be substantially the same size on either display screen.

15. A system to provide a cohesive user experience when using multiple displays, the system comprising:
at least one processor;
at least one memory device operably coupled to the at least one processor and storing instructions for execution on the at least one processor, the instructions causing the at least one processor to:
display a first graphical element on a first display screen;
display a second graphical element on a second display screen;
enable a user to move at least one of the first and second graphical elements until the first and second graphical elements are substantially aligned with one another across the first and second display screens;
enable a user to resize at least one of the first and second graphical elements until the first and second graphical elements are scaled similarly on the first and second display screens;
automatically adjust a relative understood position of the first and second display screens in accordance with the move; and
automatically scale graphical objects spanning the first and second display screens in accordance with the resize.

16. The system of claim 15, wherein enabling a user to move at least one of the first and second graphical elements comprises enabling a user to drag at least one of the first and second graphical elements.

17. The system of claim 16, wherein enabling a user to drag at least one of the first and second graphical elements comprises enabling a user to drag at least one of the first and second graphical elements using one of a cursor, finger, and stylus.

18. The system of claim 15, wherein enabling a user to resize at least one of the first and second graphical elements comprises enabling a user to visually resize at least one of the first and second graphical elements using one of a cursor, finger, and stylus.

19. The system of claim 15, wherein substantially aligned is one of substantially vertically aligned and substantially horizontally aligned.

20. The system of claim 15, wherein the first and second graphical elements are rectangles.
